(19) United States
(12) Patent Application Publication
(10) Pub. No.: US 2017/0232929 A1
(43) Pub. Date: Aug. 17, 2017

(54) Torso Support System For Protecting Against Upward Accelerations In Vehicle Seats And Occupant Support Structures

(71) Applicant: USSC Acquisition Corp., Exton, PA (US)

(72) Inventor: John-Paul McGovern, Chester Springs, PA (US)

(21) Appl. No.: 15/434,767

(22) Filed: Feb. 16, 2017

Related U.S. Application Data
(60) Provisional application No. 62/295,916, filed on Feb. 16, 2016.

(51) Int. Cl. B60R 22/26; B64D 11/06; B60R 22/02

(52) U.S. Cl. CPC B60R 22/26; B60R 22/02; B64D 11/062

(57) ABSTRACT

An improved occupant restraint system is provided which includes a torso support unit that provides external support to an upper torso of an individual, who may be the occupant of a vehicle exposed to upward acceleration events. The torso support system provides support to the occupant's upper torso including rib cage, arm pit, upper arm and/or shoulder region. This support can be accomplished by one or more straps, one or more bars, one or more hooks or any other support device(s) that are connected to structure of the vehicle, such as a seat or standing platform, and in turn connected to the upper torso of the occupant to transfer upward vehicle forces to various parts of the upper torso independently of the forces transferred to the lower body such as the feet, legs and seat through other vehicle structure. With such a torso support system, when an upward acceleration event occurs, the compressive forces impinging on the occupant's spinal column are reduced wherein the likelihood of occupant paralysis or death due to spinal and other acceleration-induced injuries are significantly reduced.

### CROSS REFERENCE TO RELATED APPLICATIONS

This application asserts priority from provisional application 62/295,916, filed on Feb. 16, 2016, which is incorporated herein by reference.

### FIELD OF THE INVENTION

The invention relates to an improved harness system for protecting vehicle occupants from violent or abrupt accelerations and forces, such as: upward accelerations and forces from mine blasts, improvised explosive devices (IEDs) and the like; forward and side accelerations and forces from crash events; and multi-axis accelerations and forces from roll-over events and the like.

### BACKGROUND OF THE INVENTION

The present invention relates to the field of protecting of seat occupants from accelerations and forces, particularly from below. Potential applications for this invention include but are not limited to various types of seating in vehicles subject to risk of abrupt, high energy accelerations, which may be violent or extreme, such as ground vehicle seating, military seating, aircraft seating, marine seating, stationary seating or standing platforms in any of these applications. Current seating and standing platforms in such applications generally offer support to the occupant or individual only from below the occupant's spinal column. In the case of a seat system or platform with no harness or with a conventional safety harness, an abrupt acceleration from below the platform will induce compressive forces within the body of the occupant proportional to the mass of the occupant's body above any given point. If these accelerations are forceful, abrupt or violent, injury may still occur even when the occupant is not ejected or thrown.

To take the example of seating systems in various vehicles including ground vehicles, aircraft and marine vessels, an acceleration from below may be great enough in magnitude such that the acceleration can induce permanent paralysis, spinal injury and/or other potentially fatal injuries in the occupant. Essentially, the force of the acceleration, such as from a blast or IED, may be transferred to the internal body tissues and skeleton including the spine. The invention is suitable for vehicle applications that may be subject to frequent, regular, repetitive or continuous shocks, jolts and accelerations during normal travel or other ordinary use, wherein the present invention also protects against the different scenario of a substantially greater acceleration and magnitude such as those encountered in a military vehicle hitting an IED, mine or other explosive device, which are extraordinary events. This latter type of extraordinary event is a single, extremely high energy event which occurs rapidly if not instantaneously and imparts extreme upward accelerations and forces, although multiples of such events could occur in a short time period. This single event could be followed by another or successive events such as may occur during slam down after a mine blast, IED or rollover.

Extensive research has been conducted by the U.S. military, foreign militaries and civilian markets in this area, with the goal of protecting occupants to the highest degree possible when subjected to such high energy events. However, to date, the means of protection for occupants has been limited to the dissipation of energy by means of some sort of whole seat suspension system, seat cushion systems, damping systems and others. In short, and since energy cannot be destroyed, such a known system aims to reduce the maximum accelerations experienced by the occupant by spreading this acceleration out over a longer period of time, thus reducing the likelihood of injury. However, when safety harnesses or seat belts are employed in such systems, they are typically of standard automotive 2 or 3 point design or of a more advanced design with 4, 5 or 6 point designs. This applies both to a seat where the occupant is seated in a conventional position, or to standing platforms where the occupant is in a standing position or a sit-stand position but restrained by a harness.

Of important note, while such harnesses play a role in keeping the occupant positioned in the seat during an upward acceleration event, the main function of such harness systems is for protection of the occupant in longitudinal crash events—such as forward impact, side impact, and rear impact and rollover. Due to the requirements of Federal Motor Vehicle Safety Standards in the U.S., and comparable requirements around the world, detailed specifications are set forth regarding these harness systems and their application to seats. As best understood, most restraint systems and harnesses that contain upper body protection currently used in the applications discussed above, pass over the top of the occupants' shoulders. As will be described herein, the present invention differs from this type of system since the prior art system is not specifically designed to support the occupant's torso weight from above, in the event of vertical acceleration events.

As a result of these known configurations, even in seat systems or standing platforms with the most advanced restraint harnesses, when an upward acceleration event occurs, the only structural support available to support the downwardly-directed force (from the perspective of the occupant) and weight of the occupant's upper torso on his/her lower body is the occupant's own spinal column. As such, spinal injury is a prevalent injury for individuals exposed to upward accelerations since the upward accelerations driven first to the lower body are primarily driven to the upper torso through the spinal column resulting in compressive forces in the spine, or spinal compression

To overcome disadvantages associated with known harness systems, the current invention relates to a torso support unit that provides external support to an upper torso of an individual, who may be the occupant of any vehicle including, but not limited to, a ground vehicle, aircraft or waterborne vessel exposed to upward acceleration events. This torso support can be accomplished by a variety of means according to the present invention. In general, support will be provided to the occupant's upper torso including rib cage, arm pit, upper arm and/or shoulder region. This support can be accomplished by one or more straps, one or more bars, one or more hooks or any other type of support device(s) or connection(s) that are attached to structure of the vehicle, standing platform or seat system and in turn connected to the upper torso of the occupant to transfer upward vehicle forces to various parts of the upper torso independently of and in parallel to the forces transferred to the lower body such as the feet, legs and seat through other vehicle structure. This torso connection may be rigid or flexible. This connection may or may not connect to a vest or other equipment worn by the occupant. By means of such a torso support system, when an upward acceleration event occurs, the compressive forces impinging on the occupant's spinal column will be reduced as compared to seats, platforms or vehicles with currently available harness systems or no harness system at all. As such, the likelihood of occupant paralysis, spinal injury or death and other acceleration-induced injuries will be significantly reduced.

By means of the present invention, and the increased upper torso support described above, undesirable and potentially injurious body motions in directions other than upward can also be prevented. One such type of motion is known as “submarining” in a forward crash or rollover vehicle event. Submarining occurs when an occupant slides underneath of a 2, 3, 4 or 6 point harness system. When this occurs the occupant's legs can contact surrounding vehicle structure at in an unsafe manner, creating compressive and injurious forces in the occupant's legs, pelvis, spine, rib cage, soft tissue and other bodily organs and structures. This type of motion is one reason for the inclusion of the “crotch strap,” or lower central strap in a conventional 5 point harness system. However, inclusion of such a 5^{th} point is often associated with occupant discomfort, thus often leading to harnesses not being worn. By means of supporting the upper torso of an occupant, and in contrast to current conventional harness systems, the present invention reduces or completely alleviates the issue of submarining without the need for a crotch strap or 5^{th} point.

In one embodiment of the present invention, the torso support system comprises torso support bars which project from a seat back or support structure proximate the occupant's shoulders wherein said support bars are positioned under the occupant's arm pits in use. These support bars define upward facing support surfaces that are disposed underneath portions of the upper torso, such as the arm pits, so that upward acceleration and forces of the seat and interconnected support bars also imparts acceleration and force to the upper torso. This torso acceleration is imparted separate from the upward acceleration and forces that may be applied to the occupant's lower body, feet and seat, i.e. buttocks area, by the lower portion of the seat structure. Hence, the lower body and upper torso are each accelerated by different vehicle support structures, which reduces or eliminates the transfer of acceleration and force between the lower body and upper torso through the spinal structure disposed therebetween.

In a second embodiment of the invention, the torso support system comprises one or more support straps passing under the occupant's arm pits which may pass over or across the front of the chest or shoulders, wherein it is possible to integrate this inventive embodiment with components of traditional harness systems. This inventive embodiment may also provide all necessary support and restraint for the occupant's upper body while a traditional 2-point lap harness supports and restrains the lower body. Examples of such integration with traditional harness components could include single or multiple point release mechanisms, automatic or manually adjusting support mounting height systems, automatic retracting reel systems for facilitation of upper body movement while still wearing the harness and automatic tensioning systems. Preferably, the straps are substantially non-stretchable or designed to stretch a precise amount, flexible and adjustable so as to flexibly conform to the upper torso during occupant movements. Here again, the support straps are directly connected to the vehicle support structure wherein upward acceleration is transmitted to the upper torso, separate from the transfer of acceleration and forces to the lower body, such as feet, legs and seat of the occupant.

In a third embodiment of the invention, a hook or ledge located in the seat or platform back area, approximately at the center of the occupants back when seated or standing could interface with a mating hook or ledge in the occupant's equipment. The hook rigidly mounted to the vehicle would be facing with its open side facing upward, while the hook on the occupant's equipment would be facing downward such that when the occupant is seated, the two hooks interlock. If upward accelerations are then imparted into the vehicle structure, the forces passed to the occupant through the vehicle structure will pass simultaneously or very closely in time through the interlocking hooks and the traditional lower seating surface of the seat. Thus, forces in the occupant's spine will be minimized due to the supporting nature by the hooks of the occupant's upper torso.

Such systems of the present invention have the added benefit of supporting a side facing occupant in a frontal crash. By securing the occupant's torso to limit movement of the occupant across the front face of the support structure or seat, the proposed invention limits the horizontal movement of the side facing occupant. This is a significant advantage in that many armored personnel carriers and other military vehicles have the crew mounted in side facing seats, wherein the present invention also supports the occupant's in the direction of forward vehicle movement.

While it is noted that a system located under the arms could potentially injure an occupant, it is believed that any such injuries likely will be less severe in comparison to a broken, severed or compressed spine. This injury potential could be further mitigated with the incorporation of one or more of the following into the torso support system of the present invention: padding, adjustability of the harness system, flexibility of the harness system, more or less contact surface area between the harness system and the occupant. Additionally, the torso support system may be configured to contact certain areas of the upper torso such as the chest and rib cage and not others such as the collarbone so as to transfer upward acceleration and force to these areas of the occupant's body while minimizing injury to said areas of contact.

Preferably, the invention will provide for the ability to adjust the upper supports, such as the posts or straps. Tall occupants may need the belts or bars higher up than shorter occupants. Heavier/brawnier occupants will need the supports further apart than lighter/thinner occupants. The support belts may allow adjustability to be implemented through adjustable buckles or movable anchors, while the bars may include support structures or anchors that allow for movement of the anchor points or mounting locations for the bars.

Preferably, the belt system should have a release buckle that may be centrally mounted although the buckle could be located at other positions. Rapid and reliable egress is very important in military and emergency vehicle applications. By having a release buckle centrally located, any occupant or third party can release the belts. In a harness system with bars or hooks to support the upper torso, these support structures would be disengaged by the action of the occupant standing, or lifting or being lifted upward in case of emergency.

Other objects and purposes of the invention, and variations thereof, will be apparent upon reading the following specification and inspecting the accompanying drawings.

### BRIEF DESCRIPTION OF THE DRAWINGS

FIG. 1 is a perspective view illustrating an exemplary military ground vehicle seat outfitted with a 5-point ABTS (all-belts-to-seat) harness.

FIG. 2 is a perspective view of the seat of FIG. 1 illustrating the typical military seat with an occupant wearing the 5-point ABTS harness (where the 5 points of the harness would typically be connected at or near the area of the occupant's pelvis or abdomen).

FIG. 3 is a perspective view of the seat of FIG. 2 with an idealized occupant body seated therein.

FIG. 4 is a diagrammatic perspective view illustrating an occupant spinal loading scenario when the occupant is subjected to vertical acceleration in a traditional blast seat without a harness or with a conventional harness system.

FIG. 5 is a perspective view illustrating a first embodiment of a vehicle seat according to the present invention wherein the seat includes a torso support unit configured as torso support bars for supporting the upper body of the occupant.

FIG. 6 is a perspective view of the seat embodiment of FIG. 5 with an idealized occupant body seated therein with the torso support bars positioned under the occupant's armpits.

FIG. 7 is a diagrammatic perspective view illustrating an occupant spinal loading scenario when the occupant is subjected to vertical acceleration with the present invention employed in a blast seat.

FIG. 8 is a perspective view of a second embodiment of a vehicle seat according to the present invention wherein the seat includes a torso support unit configured as a torso support strap for supporting the upper body of the occupant.

FIG. 9 is a perspective view of the seat embodiment of FIG. 8 with an idealized occupant body seated therein with the torso support strap positioned under the occupant's armpits and across the torso.

FIG. 10 is a perspective view of a modified form of the second embodiment wherein the torso support strap is shown coming down and supporting the occupant in a vertical orientation. This strap could also come down over the occupants shoulders pass under the arms, then connect to itself or to the seat structure behind the occupant's back.

FIG. 11 is a table of test results comparing the present invention relative to a conventional 5 point safety harness.

FIG. 12 is a perspective view of a third embodiment of the invention.

FIG. 13 is an enlarged partial side view of complementary connectors provided in the embodiment of FIG. 12.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

### DETAILED DESCRIPTION

Generally, the present invention relates to the field of protecting of seat occupants from accelerations from below. Potential applications for this invention include but are not limited to various types of seating in vehicles subject to risk of abrupt, high energy accelerations, which may be violent or extreme, such as ground vehicle seating, aircraft seating, marine seating, stationary seating or standing platforms in any of these applications.

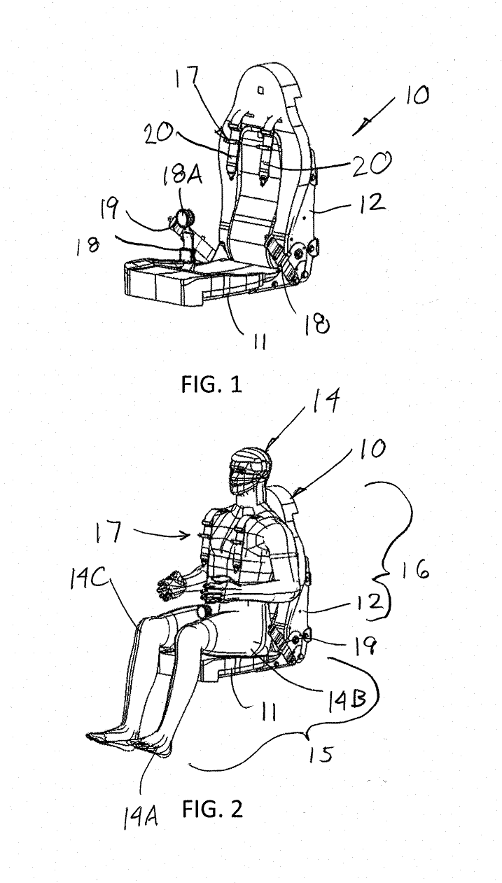

Referring to FIG. 1, current seating and standing platforms in such applications generally offer support to the occupant or individual only from below. FIG. 1 illustrates an example of a typical seat assembly or system 10, which comprises an upward-facing seat support 11 and a forward-facing back rest 12. For reference purposes, the forward direction relative to the back rest 12 refers to the forward face thereof that contacts the back of a vehicle occupant. In some applications, this forward direction may face in the same forward direction as the direction of travel of the vehicle when the seat faces in this direction, but in others, the forward seat direction may face sidewardly or rearwardly relative to the vehicle's travel direction. In other situations, the seat unit 10 may rotate and face in any direction relative to the vehicle's direction of travel. In the seat assembly 10, the occupant 14 may sit in the position illustrated in FIG. 2, with the occupant's feet 14A resting on the floor or a foot rest and the occupant's seat or buttocks 14B disposed on the seat support 11.

In the case of a seat system 10 or a platform without a safety harness or even with a conventional safety harness, an abrupt acceleration from below the platform will induce compressive forces within the body of the occupant 14 proportional to the mass of the occupant's body above any given point. If these accelerations are forceful, abrupt or violent, injury may still occur even when the occupant is not ejected or thrown. In a typical scenario, the upward acceleration of the vehicle may be transferred to the lower body 15 (FIG. 2) of the occupant 14 through the occupant's seat area 14B and/or if the occupant 14 is in a standing position, through the legs 14C. If in a sit-stand position, the upward acceleration may be transferred to both the seat area 14B and the legs 14C. To help prevent the occupant from being thrown or ejected, the seat system 10 may include a conventional harness 17.

In more detail as to the example of seating systems 10 in various vehicles including ground vehicles, aircraft and marine vessels, an acceleration from below the occupant's spinal column may be great enough in magnitude such that the acceleration can induce permanent paralysis, spinal injury and other potentially fatal injuries in the occupant 14. Essentially, the force of the acceleration, such as from a blast, may be transferred to the lower body 15 and then to the upper torso 16 through internal body tissues and the skeleton including the spine. Some vehicle applications may be subject to frequent, regular, repetitive or continuous shocks, jolts and accelerations during normal travel or other ordinary use and the inventive support system being suitable for such applications. The present invention also protects against the different scenario where the vehicle encounters a substantially greater upward acceleration and magnitude such as those encountered in a military vehicle hitting an IED, mine or other explosive device, which are extraordinary events. This latter type of extraordinary event is a single, extremely high energy event which occurs rapidly if not instantaneously and imparts extreme upward accelerations and forces. Less frequently, there may be multiple such events which could occur in a short time period or quick succession, such as through the detonation of multiple explosives, or slam down after a mine blast, IED or rollover. Additionally, such extraordinary events may encompass crash events which impart forward and side accelerations and forces, and other events such as rollover events which impart multi-axis accelerations and forces.

When safety harnesses or seat belts are employed in such systems, they are typically of standard automotive 2 or 3 point design or of a more advanced design with 4, 5 or 6 point designs. The illustrated harness 17 is shown as a 5-point design for illustrative purposes. In this design, the harness 17 comprises: a central strap 18 with a main buckle 18A; left and right lap belt sections 19 which may be extendible from the sides to releasably buckle or lock into the main buckle 18A to secure the lap of the occupant 14; and a pair of shoulder straps 20 which may be retractably extended from above to releasably buckle or lock into the main buckle 18A to vertically restrain the shoulders of the occupant 14 in one vertical direction.

Without a harness 17, the seat support 11 only provides vertical support to the occupant 14 from below while the occupant may be ejected upwardly during a vertical acceleration. The back rest 12 only provides rearward support while providing minimal frictional resistance during an upward acceleration, which disappears if the occupant 14 loses contact with the back rest surface. When a harness 17 is provided, such harnesses 17 secure the lap and shoulders of the occupant 14 to keep the occupant positioned in the seat 10 or on the support platform during an upward acceleration event. The lap belt sections 19 impede upward separation of the lower body 15 from the seat support 11 while the shoulders belts 20 restrain and prevent upward displacement of the occupant's torso 16 relative to the seat back 12. Such shoulder belts 20 do not restrain downward displacement of the torso 16. As such, the primary function of such harness systems is for protection of the occupant in longitudinal crash events—such as forward impact, side impact, and rear impact and rollover. One significant problem is that the upper torso 16 is unrestrained downwardly and is still able to move independently of the lower body 15 during an abrupt, upward acceleration.

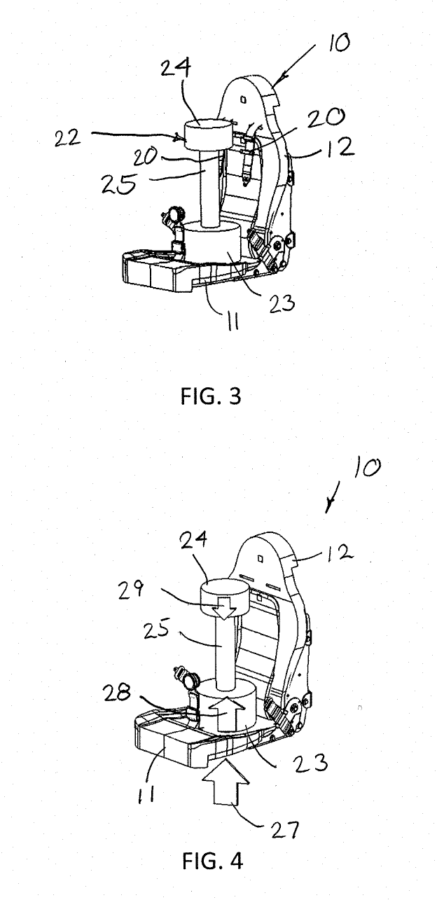

Referring to FIGS. 3 and 4, the occupant 14 is represented by an idealized body unit 22 disposed on the conventional seat system 10. An enlarged lower portion 23 represents the weight or mass of the lower body 15 seated on the seat unit 11. A smaller upper portion 24 represents the weight or mass of the upper torso 16 which is interconnected to the lower portion 23 by a thinner, upright column 25, which represents the spinal column of the occupant 14. This column 25 is thinner since the skeleton and specifically the spinal column and associated soft tissues provides a smaller capacity for structurally supporting vertical forces transferred between the lower portion 23 representing the lower body 15 and the upper portion 24 representing the upper torso 16.

FIG. 4 further represents the transfer of forces during a vertical acceleration event. In this regard, reference arrow 27 represents a large vertical force applied to the seat system 10 of the high energy type reference above. Such a force 27 might result from the blast from an IED, mine or other explosive device. This high energy force 27 is transferred vertically through the seat unit 11 to the lower body 15 of the occupant 14 (represented by lower portion 23) to generate an upward acceleration and force on the body mass as represented by reference arrow 28. If the occupant 14 is wearing the harness 17, the occupant 14 is not lifted or ejected from the seat unit 11 due to the vertical restraint provided by the lap belts 19. As such, the lower body 15 of the occupant 14 moves upwardly in unison with the seat unit 11. In turn, this movement of the lower body 15 is transferred to the upper torso 16 by the spinal column. The harness 17 does not assist in this transfer of acceleration and force since the shoulder straps 20 only restrain the shoulders vertically in the upward direction, while allowing free movement of the upper torso 16 in the downward direction. As such, the upper torso 16 and the weight and mass thereof initially resists upward movement and imparts a downward compression force on the column 25 as indicated by reference arrow 29 in FIG. 4. The smaller support structure of the spinal column is represented by the thin column 25 wherein the oppositely directed forces 27 and 29 act to compress the spinal column, which increases the risk of traumatic spinal injuries as result of a high energy acceleration force 27 from below.

Therefore, even in seat systems or standing platforms with the most advanced restraint harnesses, when an upward acceleration event occurs, the only structural support available to support the downwardly-directed force and weight 29 of the occupant's upper torso 16 on his/her lower body 15 is the occupant's own spinal column 25. As such, spinal injury is a prevalent injury for individuals exposed to high energy, upward accelerations of this type since the upward accelerations 27 are driven first to the lower body 15 and then are primarily driven to the upper torso 16 through the spinal column 25.

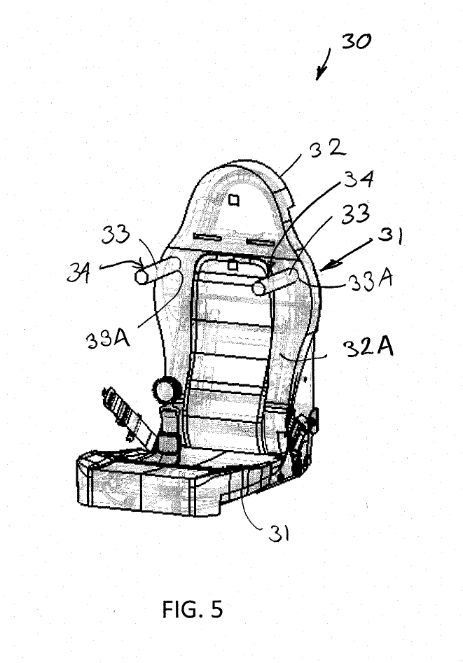

To overcome disadvantages associated with known harness systems 17, FIGS. 5-7 illustrate a first embodiment of the present invention, which comprises an improved seat system 30 in combination with a torso support unit 31 that provides external support to an upper torso 16 of an individual 14, who may be the occupant of any vehicle including, but not limited to, a ground vehicle, aircraft or waterborne vessel exposed to high energy, upward acceleration events. The seat system or assembly may comprise an upward-facing seat support 31 and a forward-facing back rest 32.

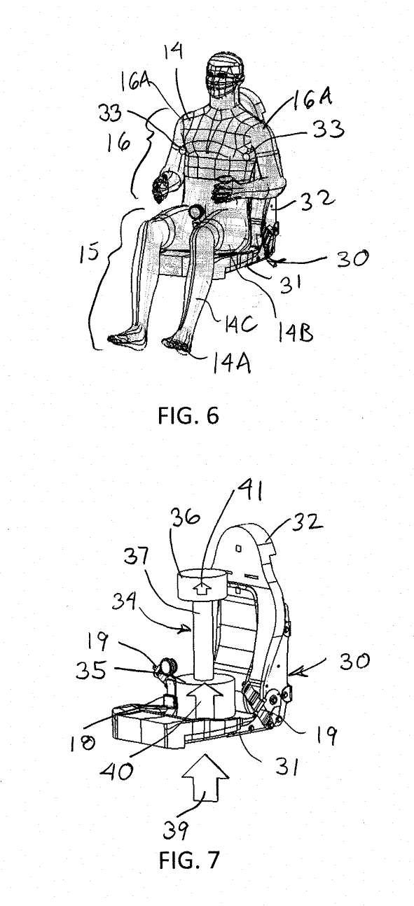

With respect to the present invention, the forward direction relative to the back rest 32 refers to the forward seat face that contacts the back of a vehicle occupant 14. In some applications, this forward direction may face in the same forward direction as the direction of travel of the vehicle, but in other situations, the forward seat direction may face sidewardly or rearwardly relative to the vehicle's travel direction, or still further, the seat unit 30 may rotate and face in any direction relative to the vehicle's direction of travel. The invention is described herein relative to the seat assembly 30 in which the occupant 14 sits in the position illustrated in FIG. 6, with the occupant's feet 14A resting on the floor or foot rest and the occupant's seat or buttocks 14B disposed on the seat support 31. It will be understood that other vehicle support structures or platforms may be provided which may support the occupant 14 in a standing position or a sit-stand position. Such support platforms or structure may include a back rest type structure, like back rest 31, against which the occupant 14 may lean during use.

In the case of the inventive seat system 30 or the variation comprising a platform, an abrupt acceleration from below the seat or platform will normally tend to induce compressive forces within the body of the occupant 14 proportional to the mass of the occupant's body above any given point. If these accelerations are forceful, abrupt or violent, the present invention helps to prevent the occurrence of injury when the occupant 14 is not ejected or thrown but undergoes substantial vertical acceleration and forces as well as other forces. In this scenario, the upward acceleration of the vehicle may be transferred to the lower body 15 (FIG. 6) of the occupant 14 through the occupant's seat area 14B and/or if in a standing, through the legs 14C. If in a sit-stand position, the upward acceleration may be transferred to both the seat area 14B and the legs 14C. In order to prevent or reduce the injuries described above due to the different, oppositely directed forces 28 and 29 acting in compression on the spinal column 25, the present invention includes the torso support system 31 which provides vertical support to the upper torso 16 that prevents downward displacement thereof during abrupt vertical accelerations.

This torso support can be accomplished by a variety of means according to the present invention. Generally as to the present invention, vertical torso support preferably will be provided to the occupant's upper torso 16 including rib cage, arm pit, upper arm and/or shoulder region. This support can be accomplished by one or more straps, one or more bars, one or more hooks or any other type of support device(s) that are connected to structure of the vehicle, standing platform or seat system and in turn connected to the upper torso 16 of the occupant to transfer upward vehicle forces to various parts of the upper torso 16 independently of simultaneously with the forces transferred to the lower body 15 such as the feet 14A, legs 14C and seat 14B supported by other vehicle structure. This torso connection may be rigid or flexible. By means of such a torso support system, when an upward acceleration event occurs, the compressive forces impinging on the occupant's spinal column will be reduced as compared to seats, platforms or vehicles with currently available harness systems. As such, the likelihood of occupant paralysis or death due to spinal and other acceleration-induced injuries will be significantly reduced.

In the first embodiment of the present invention shown in FIGS. 5-7, the torso support system 31 comprises a pair of torso support bars 33 which project forwardly from the seat back or support structure 32 proximate the occupant's shoulders 16A (FIG. 6) wherein said support bars 33 are positioned under the occupant's arm pits in use. These support bars 33 define upward facing support surfaces 34 that are disposed underneath portions of the upper torso 16, such as the arm pits, so that upward acceleration of the seat 3, seat back 32 and interconnected support bars 33 also imparts upward acceleration to the upper torso 16 independently of the lower body 15. The support bars 33 are generally located at anchor locations 33A.

Referring to FIG. 7, this figure represents the transfer of forces during a vertical acceleration event. In this illustration, the occupant 14 is represented by an idealized body unit 34 disposed on the seat system 30. An enlarged lower portion 35 represents the weight or mass of the lower body 15 seated on the seat unit 31. A smaller upper portion 36 represents the weight or mass of the upper torso 16 which is interconnected to the lower portion 35 by a thinner column 37, which represents the spinal column of the occupant 14 and associated tissue. This column 37 is thinner since the skeleton and specifically the spinal column and associated soft tissues provides a smaller capacity for structurally supporting vertical forces transferred from the lower portion 35 representing the lower body 15 to the upper portion 36 representing the upper torso 16.

In more detail as to the distribution of forces, reference arrow 39 represents a large vertical force applied to the seat system 30. In accord with the above descriptions of such forces like force 27, this force 39 might result from the blast from an IED, mine or other explosive device although protecting against other abrupt, extraordinary forces is encompassed within the scope of this invention. This force 39 is transferred vertically through the seat unit 31 to the lower body 15 of the occupant 14 (represented by lower portion 35) to generate an upward acceleration and force on the body mass represented by reference arrow 40.

If the occupant 14 is wearing a harness 17 such as the central buckle 18 and lap belt sections 19, the occupant 14 is not lifted or ejected from the seat unit 11 due to the vertical restraint provided by the lap belts 19. As such, the lower body 15 of the occupant 14 is restrained downwardly and moves upwardly in unison with the seat unit 11. To protect the occupant 14 from injury, this movement of the lower body 15 is isolated from the upper torso 16 by the torso support system 31. The support bars 33 are connected to the seat structure and in the illustrated embodiment, directly and rigidly to the seat back 32. As such, upward acceleration and forces applied to the seat system 30 as represented by arrow 39 are transferred from the rigid seat system 30 to the upper torso 16 through the support bars 33. As mentioned above, these support bars 33 are positioned under the arm pits or shoulders 16A and define an upper surface 34 that acts vertically upwardly on the upper torso 16. This effects displacement of the upper torso 16 upwardly in unison with the back rest 32 during a high energy event. The upward acceleration and forces on the upper torso are represented by reference arrow 41 in FIG. 7.

While a harness 17 does not assist in this transfer of the upper torso 16 since the shoulder straps 20 only restrain the shoulders vertically in the upward direction, the support bars 33 do not allow free movement of the upper torso 16 in the downward direction but instead displace the upper torso 16 upwardly and simultaneously in the same direction as the lower body 15. This minimizes if not eliminates compression of the spinal column by moving the upper torso 16 and lower body 15 together in the upward direction, which protects the spinal column from compressive forces during a high energy event. This upward torso acceleration is imparted by the torso support system 31 separate from the upward acceleration and forces that may be applied to the occupant's lower body, feet and seat, i.e. buttocks area, by the lower portion 31 of the seat structure 30. Hence, the lower body 15 and upper torso 16 are each accelerated by different vehicle support structures, i.e. the back rest 32 and seat support 31, which reduces or eliminates the transfer of acceleration and force between the lower body 15 and upper torso 16 through the spinal structure disposed therebetween. Even if a harness 17 is not present, the torso support system 34 is still effective in displacing the upper torso 16 simultaneously with the lower body 15 to avoid spinal compression.

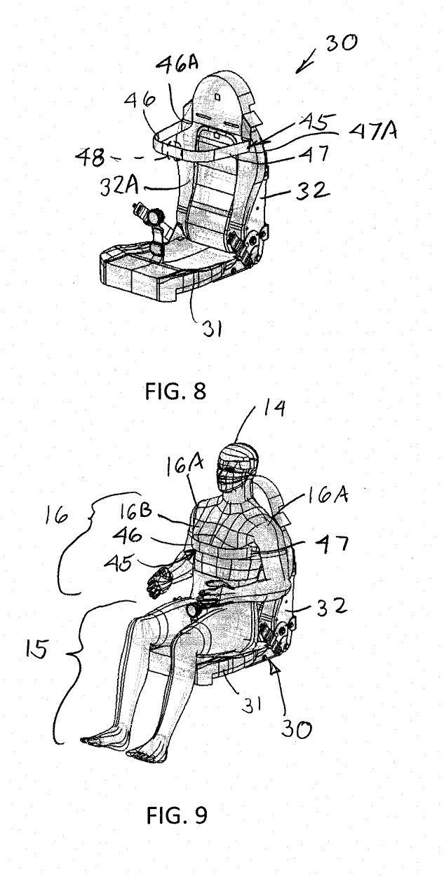

In a second, preferred embodiment of the invention illustrated in FIGS. 8 and 9, a torso support system 45 comprises one or more support straps 46 and/or 47 passing under the occupants arm pits and shoulders 16A and across the front of the chest 16B. With this embodiment, it is possible to integrate this inventive embodiment with components of traditional harness systems 17. Examples of such integration would include single or multiple point release mechanisms, automatic or manually adjusting support mounting height systems, automatic retracting reel systems for facilitation of upper body movement while still wearing the harness and automatic tensioning systems. For example, the straps 46 and 47 each connect at anchor locations 46A and 47A to the back rest 32. At these locations 46A and 47A, the anchor locations may comprise automatic retracting reel systems mounted to the back rest 32 that allow extension and retraction of the straps 46 and 47 for free upper body movements, while being automatically lockable upon a high energy acceleration event such as those described herein. Preferably, the straps 46 and 47 are substantially non-stretchable but flexible so as to flexibly conform to the upper torso during occupant movements, which improves comfort. While the straps 46 and 47 are substantially non-stretchable, the straps 46 and 47 may still be designed to stretch a precise or limited amount.

The support straps 46 and 47 are directly connected to the vehicle support structure wherein upward acceleration is transmitted to the upper torso 16, separate from the transfer of acceleration and forces to the lower body 15, such as feet, legs and seat of the occupant. These support straps 46 and 47 are disposed underneath portions of the upper torso 16, such as the arm pits, so that upward acceleration of the seat 31, seat back 32 and interconnected support straps 46 and 47 also imparts upward acceleration to the upper torso 16 independently of the lower body 15.

The force diagram for this second embodiment of the torso support system 45 is basically the same as that described above relative to FIG. 7. As such, a separate figure showing the idealized forces is not provided for this second embodiment, although the occupant 14 of FIG. 9 can still be represented by the same idealized body unit 34 shown in FIG. 7. The support straps 46 and 47 function similar to the support posts 33, wherein: the enlarged lower portion 35 represents the weight or mass of the lower body 15 seated on the seat unit 31; and the smaller upper portion 36 represents the weight or mass of the upper torso 16 which is interconnected to the lower portion 35 by a thinner column 37, which represents the spinal column of the occupant 14. With the torso support system 45, the force 39 would still be transferred vertically through the seat unit 31 to lower body 15 of the occupant 14 (represented by lower portion 35) to generate an upward acceleration and force on the body mass represented by reference arrow 40. The torso support system 45 also protects the occupant 14 from injury since the movement of the lower body 15 is isolated from the upper torso 16 by the torso support system 45. The support straps 46 and 47 are connected to the seat structure and in the illustrated embodiment, directly and rigidly to the seat back 32. As such, upward acceleration and forces applied to the seat system 30 as would be represented by arrow 39 (FIG. 7) are transferred from the rigid seat system 30 to the upper torso 16 through the support straps 46 and 47. This effects displacement of the upper torso 16 upwardly in unison with the back rest 32 during a high energy event. For system 45, the upward acceleration and forces on the upper torso 16 also would be represented by reference arrow 41 in FIG. 7.

The support straps 46 and 47 do not allow free movement of the upper torso 16 in the downward direction but instead restrain and displace the upper torso 16 upwardly in the same direction as the lower body 15. Here again, this minimizes if not eliminates compression of the spinal column by moving the upper torso 16 and lower body 15 together in the upward direction, which protects the spinal column from compressive forces during a high energy event. This upward torso acceleration is imparted by the torso support system 45 separate from the upward acceleration and forces that may be applied to the occupant's lower body, feet and seat, i.e. buttocks area, by the seat section 31 of the seat system 30. Hence, with the addition of the torso support system 45, the lower body 15 and upper torso 16 are each accelerated by different vehicle support structures, i.e. the back rest 32 and seat support 31, which reduces or eliminates the differential transfer of acceleration and force between the lower body 15 and upper torso 16 through the spinal structure disposed therebetween to avoid spinal compression.

Such systems 34 and 45 of the present invention have the added benefit of supporting a side facing occupant 14 in a frontal crash. By securing the occupant's torso 16 to limit movement of the occupant 14 across the front face 32A (FIGS. 5 and 7) of the support structure or seat system 30, the torso support systems 34 and 45 of the present invention limit the horizontal movement of the side facing occupant 14. This is a significant advantage in that many armored personnel carriers and other military vehicles have the occupants 14, i.e. crew, mounted in side facing seats, wherein the torso support systems 34 and 45 restrain the occupants 14 sidewardly across the seat face 32A to thereby support the occupant's in the direction of forward vehicle movement. This may also provide a benefit when the seat systems 30 can rotate.

Additionally, the torso support system 45 may provide additional advantages since the support straps 46 and 47 contact additional areas of the upper torso 16 including the chest 16B and associated rib cage so as to transfer upward acceleration and force to these areas of the occupant's upper torso 16 in addition to the arm pits and shoulders 16A. This configuration distributes the upward acceleration and forces over a greater area of the upper torso 16.

Preferably, the invention will provide for the ability to adjust the upper supports, such as the posts 33 or straps 46/47. Tall occupants may need the belts 46/47 or bars 33 higher up than shorter occupants. Heavier/brawnier occupants will need the supports 33/46/47 further apart than lighter/thinner occupants. The support belts 46/47 may allow adjustability to be implemented through adjustable buckles or movable anchor locations 46A and 47A, while the bars 33 may include support structures or anchors at anchor locations 33A (FIG. 5) that allow for movement of the anchor points or mounting locations 33A for the bars 33.

Preferably, the belt system 45 should have a release buckle 48 as shown in phantom outline in FIG. 9 that may be centrally mounted although the buckle 48 could be located at other positions. Rapid and reliable egress is very important in military applications. By having a release buckle 48 centrally located, any occupant or third party can release the belts.

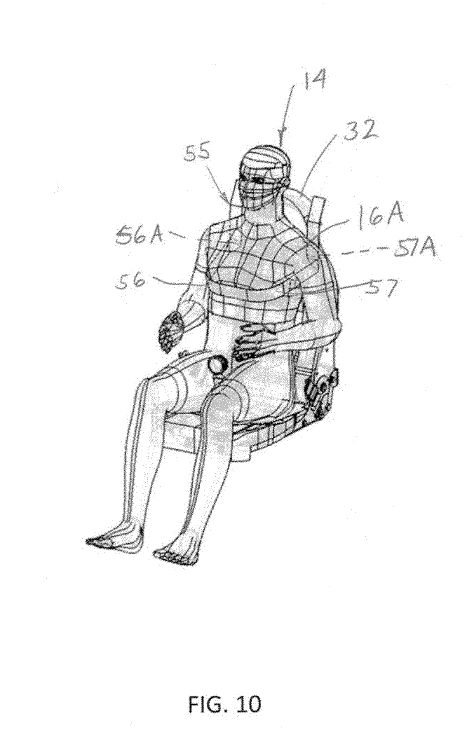

Referring to FIG. 10, a modified form of the second embodiment is shown wherein a torso support system 55 is formed similar to system 45. The torso support system 55 comprises one or more support straps 56 and/or 57 passing under the occupants arm pits and shoulders 16A and across the front of the chest 16B wherein the straps 56 and 457 each connect at anchor locations 56A and 57A to the back rest 32 such that the torso support straps 56 and 57 are shown coming down and supporting the occupant in a vertical orientation.

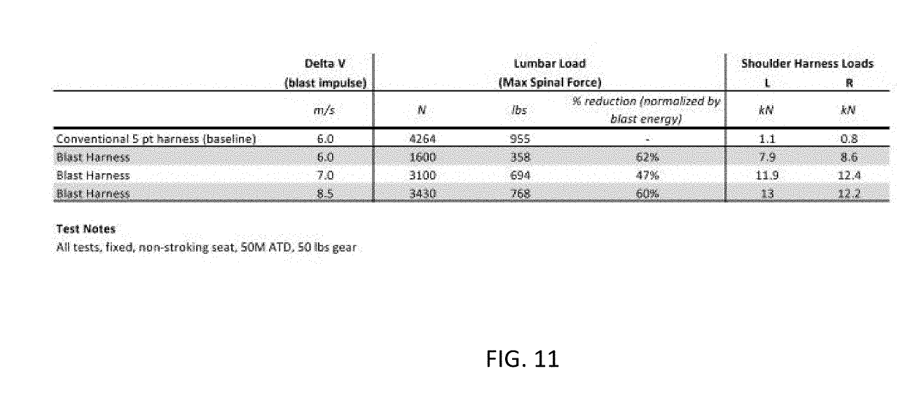

The invention of FIG. 10 has shown substantial reductions in load on an occupant's lumbar area, which would generate compressive forces in the occupant's spine. FIG. 11 shows test data for tests conducted using a fixed, non-stroking seat using a 50M ATD (50^{th} percentile, male, Anthropomorphic Test Device) with 50 lbs. of gear. As a baseline, the ATD was tested in a conventional 5 pt. harness wherein the lumbar load and shoulder harness loads for left and right (L and R) sides of the straps are shown. The blast harness of FIG. 10 was then tested on the ATD with different Delta V velocities to represent different blast impulses of 6.0, 7.0 and 8.5 m/s. The maximum spinal force for the lumbar load was reduced by 62%, 47% and 60% respectively wherein the calculations were normalized by blast energy. As can be seen, the shoulder harnesses for the 5 pt. harness take up very little vertical load, while the inventive blast harness withstood significantly higher loads.

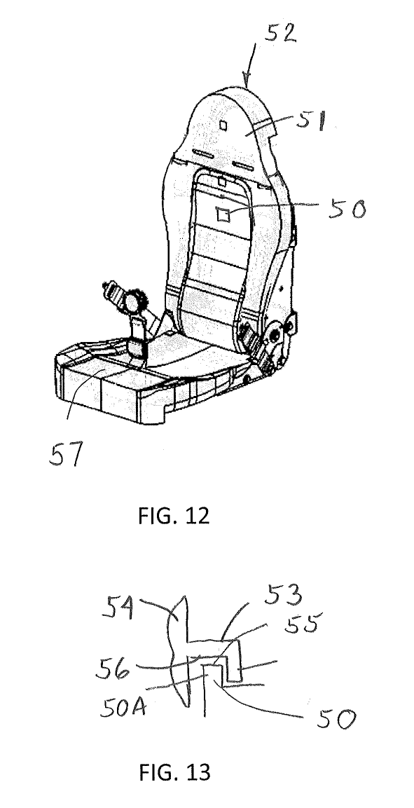

In a further embodiment of the invention as seen in FIGS. 12 and 13, one or more connectors 50 formed as a hook or ledge may be located in the back area such as the back rest 51 of the seat 52 or platform, wherein the seat connector 50 serves as an anchor. The back rest connector 50 preferably is located approximately at the center of the occupants back when seated or standing and could interface with one or more complementary connectors 53 on or worn by the occupant, wherein the occupant connector 53 may be formed as a mating hook or ledge in the occupant's equipment 54. When the back rest connector 50 is formed as a hook, the hook is rigidly mounted to the vehicle and would be facing with its open side 50A facing upward, while the hook 53 on the occupant's equipment 54 would be facing or projecting downward such that when the occupant is seated or appropriately positioned in the standing platform, the two hooks 50 and 53 interlock as seen in FIG. 13. Essentially, the two hook-like connectors 50 and 53 are separable but interlock after positioning of the occupant against the structure of the back rest 51. It will be understood that multiple back rest connectors 50 and occupant connectors 53 may be provided in spaced locations.

It will be understood that the equipment 54 can be one of a variety of forms of equipment securely worn by the occupant, including body armor, a protective vest, reinforced jacket, webbing, harness or the like that would be worn by the occupant even when out of the vehicle. If the connectors 50 and 53 are formed as a ledge, the vertical leg of the hook shape might be omitted but the connectors 50 and 53 would still abut vertically such as by abutting surfaces 55 and 56 shown in FIG. 13. Further, a version of this embodiment may be modified wherein the first, back rest connectors 50 may be formed as straps anchored to the back rest 51 and the second, occupant connectors 53 may be formed as buckles or the like on the equipment 54 wherein the occupant would buckle or interlock the straps and the equipment buckles together after positioning themselves against the structure of the back rest 51.

If upward accelerations are then imparted into the vehicle structure, the forces passed to the occupant through the vehicle structure will pass simultaneously or very closely in time through the interlocking connectors 50 and 53, which may be hooks or ledges, and through the traditional lower seating surface 57 of the seat section 58 if provided therein. As described above, the occupant could also stand on a platform, wherein the back rest 51 might be provided without the seat 58. Thus, forces in the occupant's spine will be minimized due to the supporting nature by the mating connectors 50 and 53 on the occupant's upper torso.

Although particular preferred embodiments of the invention have been disclosed in detail for illustrative purposes, it will be recognized that variations or modifications of the disclosed apparatus, including the rearrangement of parts, lie within the scope of the present invention.

We claim:

1. An occupant restraint system which is mountable to vehicle structure comprising:
a back support structure mountable to a vehicle structure, which comprises an occupant support surface that faces forwardly relative to said back support structure to define an upper area thereof that is oriented to abut an upper torso of an occupant above a lower body of the occupant;
a restraint system which is engagable with the occupant to restrain upward, forward or sideward movement of the upper torso or the lower body of an occupant relative to said back support structure; and
a torso support unit that provides external support to an upper torso of an occupant, said torso support unit being anchored to said back support structure, and being engagable with the upper torso, said torso support unit having one or more support surfaces engagable with the upper torso of the occupant to restrain vertically downward movement of the upper torso relative to said back support structure during abrupt acceleration events which cause movement of said back support structure.

2. The occupant restraint system according to claim 1, wherein said torso support unit is engagable with one of a plurality of body structures of the upper torso comprising one of an occupant's rib cage, arm pit and shoulder region.

3. The occupant restraint system according to claim 1, wherein said restraint system restrains the occupant separately from said torso support unit, which said torso support unit exclusively supports said vertically downward movement of said upper torso relative to said back support structure such that vertically upward accelerations are transmitted to the upper torso by said torso support unit separate from transfer of vertically upward accelerations transmitted to the lower body to reduce spinal compression forces between the lower body and the upper torso of the occupant.

4. The occupant restraint system according to claim 1, wherein said torso support unit is affixed to said back support structure and engages with the upper torso upon positioning of the occupant against said back support structure.

5. The occupant restraint system according to claim 4, wherein said torso support unit comprises at least one upward-facing support member which is anchored to said back support structure and projects from said back support structure to engage the occupant.

6. The occupant restraint system according to claim 5, wherein said support member is positionable within an occupant armpit and defines a respective one of said one or more support surfaces that faces upwardly and contacts the upper torso of the occupant from below the armpit to limit downward movement of the upper torso relative to said back support structure.

7. The occupant restraint system according to claim 4, wherein said torso support unit comprises one or more support straps anchored to said back support structure and positioned so as to pass under the occupant's arm pits, over or under the shoulders and across a front of the chest or behind the back, said one or more support straps restraining said vertically downward movement of the upper torso relative to said back support structure.

8. The occupant restraint system according to claim 7, wherein a plurality of said support straps are provided which have one end anchored to said back support structure and opposite free ends which are removably engagable with each other to define a loop that surrounds the upper torso.

9. The occupant restraint system according to claim 1, wherein said torso support unit comprises a first connector anchored to said back support structure in said upper area thereof, and a second connector fixable to the occupant wherein said first and second connectors are separable but interlock after positioning of the occupant against said back support structure.

10. The occupant restraint system according to claim 1, further comprising a seat support structure positioned below said back support structure and mountable to the vehicle structure to support the lower body of an occupant in a seated configuration.

11. An occupant restraint system which is mountable to vehicle structure comprising:
a lower body support structure configurable on a vehicle structure, which comprises a lower body support surface that faces upwardly to vertically support a lower body of the occupant by which vertical accelerations of said lower body support structure are imparted to the lower body of the occupant;
a back support structure mountable to a vehicle structure and disposed above said lower body support structure, said back support structure comprising a torso support surface, which faces forwardly relative to said back support structure to define an upper area thereof that is oriented to abut an upper torso of an occupant positioned on said lower body support structure;
a restraint system which is engagable with the occupant to restrain at least one of upward, forward and sideward movement of the lower body and the upper torso of the occupant relative to at least one of said lower body support structure and said upper body support structure respectively; and
a torso support unit that provides external vertical support to the upper torso of the occupant, said torso support unit being anchored to said back support structure, and engaging the occupant on a facing side of said torso support surface, said torso support unit being removably engagable with the occupant, wherein said torso support unit is engagable with the upper torso of the occupant and restrains vertically downward movement of the upper torso relative to said back support structure during vertical accelerations of said lower body support structure.

12. The occupant restraint system according to claim 11, wherein said lower body support structure is a seat and said lower body support surface faces upwardly to support the lower body when the occupant is in a seated position.

13. The occupant restraint system according to claim 11, wherein said torso support unit is affixed to said back support structure and engages with the upper torso upon positioning of the occupant against said back support structure.

14. The occupant restraint system according to claim 13, wherein said torso support unit comprises an upward-facing support member which is anchored to said back support structure and extends forwardly from said back support structure.

15. The occupant restraint system according to claim 11, wherein vertically upward accelerations are transmitted to the upper torso by said torso support unit separate from transfer of vertically upward accelerations transmitted to the lower body through said lower body support structure to reduce spinal compression forces between the lower body and the upper torso of the occupant.

16. An occupant restraint system comprising:
a lower body support structure rigidly fixable to a vehicle structure, wherein said lower body support structure defines a lower body support surface, which faces upwardly to vertically support a lower body of the occupant wherein vertical accelerations of said lower body support structure are imparted to the lower body through said lower body support surface;
a back support structure rigidly fixable to a vehicle structure on one side of and above said lower body support structure, said back support structure comprising a torso support surface, which faces forwardly relative to said back support structure and defines an upper area thereof that is oriented to abut an upper torso of an occupant positioned on the lower body support surface;
a restraint system which is engagable with the occupant to restrain vertically upward movement of at least one of the lower body and the upper torso of the occupant relative to said lower body support structure and said upper body support structure, said restraint system permitting the upper torso to move downwardly; and
a torso support unit providing vertical support to the upper torso of the occupant, said torso support unit being anchored to said back support structure in said upper area thereof, and said torso support unit being removably engagable with the upper torso of the occupant to restrain vertically downward movement of the upper torso relative to said back support structure and said lower body support surface during said vertical accelerations of said lower body support structure, wherein vertically upward accelerations are transmitted to the upper torso by said torso support unit separate from vertically upward accelerations transmitted to the lower body through said lower body structure to reduce spinal compression forces in a region between the lower body and the upper torso of the occupant.

17. The occupant restraint system according to claim 16, wherein said torso support unit comprises at least one support member defining an upward facing support surface that contacts the upper torso of the occupant from below to limit downward movement of the upper torso relative to said support member.

18. The occupant restraint system according to claim 16, wherein said torso support unit comprises one or more flexible or rigid support members anchored to said back support structure and positioned so as to pass under the occupant's arm pits and over or under the occupant's shoulders to restrain vertically downward movement of the upper torso relative to said back support structure.

19. The occupant restraint system according to claim 16, wherein said torso support unit comprises one or more first connectors anchored to said back support structure in said upper area thereof, and one or more second connectors fixable to the occupant wherein said first and second connectors are separable but interlockable, after positioning of the occupant against said back support structure.

20. The occupant restraint system according to claim 16, wherein said torso support system provides support to the upper torso in the area of at least one of an occupant's rib cage, arm pit, upper arm and shoulder region, said torso support system comprising one or more straps, one or more bars, or one or more hooks that are anchored relative to said back support structure to transfer upward vehicle forces to various parts of the upper torso independently of forces transferred to the lower body comprising any of an occupant's feet, legs and seat such that, upon the occurrence of upward acceleration of said lower body support structure, spinal compressive forces impinging on an occupant's spinal column are reduced.
